(19) United States
(12) Patent Application Publication
(10) Pub. No.: US 2010/0280853 A1
(43) Pub. Date: Nov. 4, 2010

(54) HOLISTIC MULTIMODAL TRANSPORT APPARATUS AND METHOD

(76) Inventors: Michael Thomas Petralia, Saint James, NY (US); John P. Walsh, Valley Cottage, NY (US)

Correspondence Address: THE FARRELL LAW FIRM, LLP, 290 Broadhollow Road, Suite 210E, Melville, NY, 11747, US

(21) Appl. No.: 12/746,445

(22) PCT Filed: Dec. 5, 2008
(86) PCT No.: PCT/US08/85703

§ 371 Date: Jun. 4, 2010

Related U.S. Application Data
(60) Provisional application No. 60/992,662, filed on Dec. 5, 2007.

(51) Int. Cl. G01C 21/00; G06Q 10/00; G06Q 30/00

(52) U.S. Cl. 705/5; 701/200; 705/13

(57) ABSTRACT

A method and an apparatus for providing a transportation route to a user are provided. Travel information from the user, a plurality of transportation route goals ranked in a specified order by the user, and attribute information of a plurality of transit modes from a transit information system are received by the central system. An optimized transportation route is determined for the user through a correlation of the plurality of ranked transportation route goals and attribute information that corresponds to the received travel information. The transportation route comprises one or more of the plurality of transit modes. The optimized transportation route is transmitted to the user.

### PRIORITY

This application claims priority under 35 U.S.C.§119(e) to a U.S. Provisional Patent Application filed on Dec. 5, 2007, and assigned Ser. No. 60/992,662, the disclosure of which is incorporated herein by reference.

### BACKGROUND OF THE INVENTION

1. Field of the Invention

The present invention relates generally to multi-modal transportation systems, and more particularly, to a multi-modal transportation system that provides an optimized transportation route through a correlation of a user's holistic transportation route goals and transit mode availability.

2. Description of the Related Art

Multi-modal transportation systems provide a choice between different transit modes, regardless of what is being transported; such as people, packages, energy, information, etc. Each transit mode has various attributes resulting in certain benefits and drawbacks, some unique to a given transit mode and some being more important than others. These attributes are affected by the real world and constantly vary as a result of changes to the transportation system and other real-time considerations, such as changes in system resource availability, delays, changes in costs, and changes in the transportation environment. To achieve a level of desirability, a transportation route may make use of any number of transit modes for various segments of a commute or journey.

Conventional systems have been suggested that provide a travel itinerary based on origin, destination and time, or using collection/delivery base points and relay points. See, for example, U.S. Pat. Nos. 7,082,400, 6,834,229, 5,797,113, 6,209,026, and 6,845,316.

FIG. 1 is a flow diagram illustrating a conventional system that provides a multi-modal transportation route. A user, or specifically, a commuter 100, defines a point of departure 102, a destination 104, and a time of departure 106 to a central system 108 through a system interface 110. Transportation system information 112 of different transit modes 114 is also fed to the central system 108. The transportation system information 112 may include information regarding routes, schedules and fares of each transit mode 114. A multi-modal transportation route 116 is output from the central system 108 to the commuter 100.

Changes to the transportation system 118, including traffic 120, accidents 122, and train delays 124, are output from transportation system information 112 as change information 126. The change information 126 is provided to the central system 108. If it is determined, in block 128, that this information affects the commuter's route, the commuter 100 is notified 130 of the change information 126. If it is determined, in block 128, that this information does not affect the commuter's route, no action is taken by the central system 108.

Conventional systems, such as that illustrated in FIG. 1, fail to incorporate detailed attributes for each transit mode, are unable to account for holistic transportation route goals, fail to account for the real-time changes to the transportation system, and fail to consider goals outside of price, time and location.

The benefits and drawbacks that correspond to each transit mode make it difficult to choose an optimized transportation route and require the careful balance of transportation priorities. When a user makes the choice, the available transportation priorities can quickly become unmanageable and decisions are made based on subjective views rather than objective facts. Unavailability of real-time feedback and a lack of a previously established user-specific factors result in the providing of transportation choices which are less than ideal, and sometimes contradicting in their purpose.

More difficulties arise for users due to real-time changes to transportation systems and the difficulty in timely identifying such changes. For example, in public passenger transportation systems, traffic, accidents, train delays, large public events, etc. all lead to important changes in the transportation system which will modify the attributes of each transit mode. A number of nodes or vital nodal links can unexpectedly be removed from service, affecting many other aspects of the transportation system. A user often does not have timely access to this change information, and thus cannot make informed decisions, particularly when more than one node or link becomes unavailable. In this regard, conventional systems have been proposed, such as U.S. Pat. Nos. 7,161,497 and 6,591,263, to notify users of events that impact various transit modes. However, such systems fail to provide an alternative route or recommend whether the planned route or an alternative route would best meet the user's holistic transportation route goals.

### SUMMARY OF THE INVENTION

The present invention has been made to address at least the above problems and/or disadvantages and to provide at least the advantages described below. Accordingly, an aspect of the present invention provides a method for providing a transportation route for a user at a central system.

Another aspect of the present invention provides an apparatus that provides a transportation route for a user.

A further aspect of the present invention provides a system that provides a transportation route for a user.

According to one aspect of the present invention, a method is described for providing a transportation route for a user. Travel information from the user, a plurality of transportation route goals ranked in a specified order by the user, and attribute information of a plurality of transit modes from a transportation information system are received. An optimized transportation route is determined for the user through a correlation of the plurality of ranked transportation route goals and attribute information that corresponds to the received travel information. The transportation route comprises one or more of the plurality of transit modes. The optimized transportation route is transmitted to the user.

According to another aspect of the present invention, an apparatus is described for determining a transportation route for a user. The apparatus receives travel information from the user, a plurality of transportation route goals ranked in a specified order by the user, and attribute information of a plurality of transit modes from a transit information system. The apparatus determines an optimized transportation route for the user through a correlation of the plurality of ranked transportation route goals and attribute information that corresponds to the received travel information, wherein the transportation route comprises one or more of the plurality of transit modes. The apparatus transmits the optimized transportation route to the user.

According to a further aspect of the present invention, a system is described for providing a transportation route for a user. The system includes a transit information system that provides attribute information of a plurality of transit modes to a routing system. The system also includes the routing system for receiving travel information from the user, a plurality of transportation route goals ranked in a specified order by the user, and attribute information of a plurality of transit modes from the transit information system, determining an optimized transportation route for the user through a correlation of the plurality of ranked transportation route goals and attribute information that corresponds to the received travel information, wherein the transportation route comprises one or more of the plurality of transit modes, and transmitting the optimized transportation route to the user.

### BRIEF DESCRIPTION OF THE DRAWINGS

The above and other aspects, features and advantages of the present invention will become more apparent from the following detailed description when taken in conjunction with the accompanying drawings in which:

FIG. 1 is a flow diagram illustrating a conventional system that provides a multi-modal transportation route;

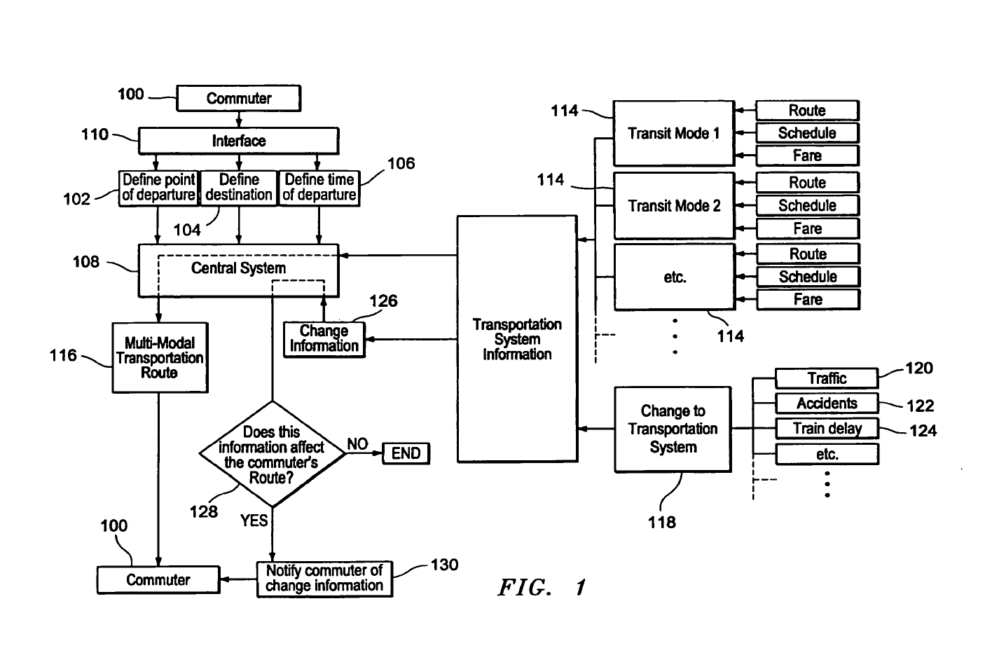

FIG. 2 is a flow diagram illustrating a system that provides a multi-modal transportation route, according to an embodiment of the present invention;

FIG. 3 is a screen shot of a Graphical User Interface (GUI) of the system, according to an embodiment of the present invention;

FIG. 4 is a screen shot of user sign-in in the system, according to an embodiment of the present invention;

FIG. 5 is a screen shot of user registration in the system, according to an embodiment of the present invention;

FIG. 6 is a screen shot of origin setting in the system, according to an embodiment of the present invention;

FIG. 7 is a screen shot of destination setting in the system, according to an embodiment of the present invention;

FIG. 8 is a screen shot of arrival/departure time setting in the system, according to an embodiment of the present invention;

FIG. 9 is a screen shot of transportation route goal ranking in the system, according to an embodiment of the present invention;

FIG. 10 is a screen shot of a multi-modal transportation route from the system, according to an embodiment of the present invention; and

FIG. 11 is a screen shot of a route change notification from the system, according to an embodiment of the present invention.

### DETAILED DESCRIPTION OF PREFERRED EMBODIMENTS

Preferred embodiments of the present invention are described in detail with reference to the accompanying drawings. In the drawings, the same or similar elements are denoted by the same or similar reference numerals even though they are depicted in different drawings. In the following description, detailed descriptions of constructions or processes known in the art may be omitted to avoid obscuring the subject matter of the present invention.

The present invention utilizes the interdependency of the various parts of a transportation system as well as a user's holistic transportation route goals and provides real-time travel options to the user. The provided options are prioritized and allow the user to choose a specific route for travel between a starting node and a terminating node. The present invention considers a plurality of transit modes, such as trains, planes, subways, buses, personal automobiles, taxies, bicycles, walking, etc., that are or can be made available for the route and is tailored to match the needs, budget and desires of the user.

An embodiment of the present invention both eliminates the subjective element of transportation route planning and helps manage varying attributes of the transit modes. The output of the system is a multi-modal transportation route providing a most effective and efficient way to satisfy a set of holistic transportation route goals, which may be modified based on real-time changes to the transportation system.

A purpose of an embodiment of the present invention is to match changing attributes of each transit mode to the holistic transportation route goals provided by the user. Users are notified if a change to the transportation system modifies a user's optimized transportation route.

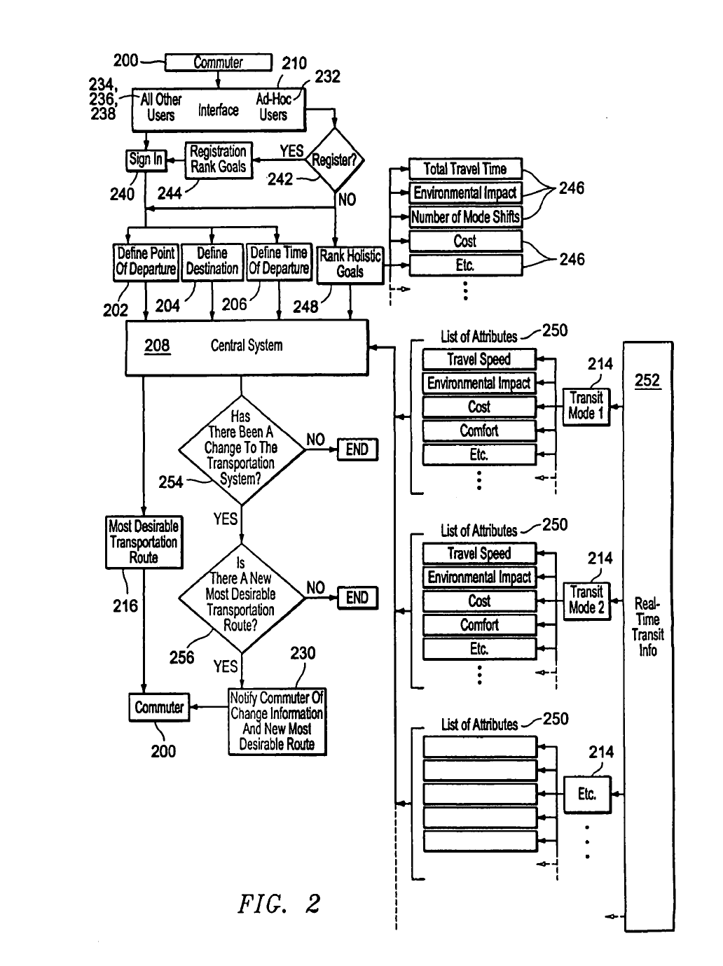

FIG. 2 is a flow diagram illustrating a system that determines an optimized transportation route, according to an embodiment of the present invention.

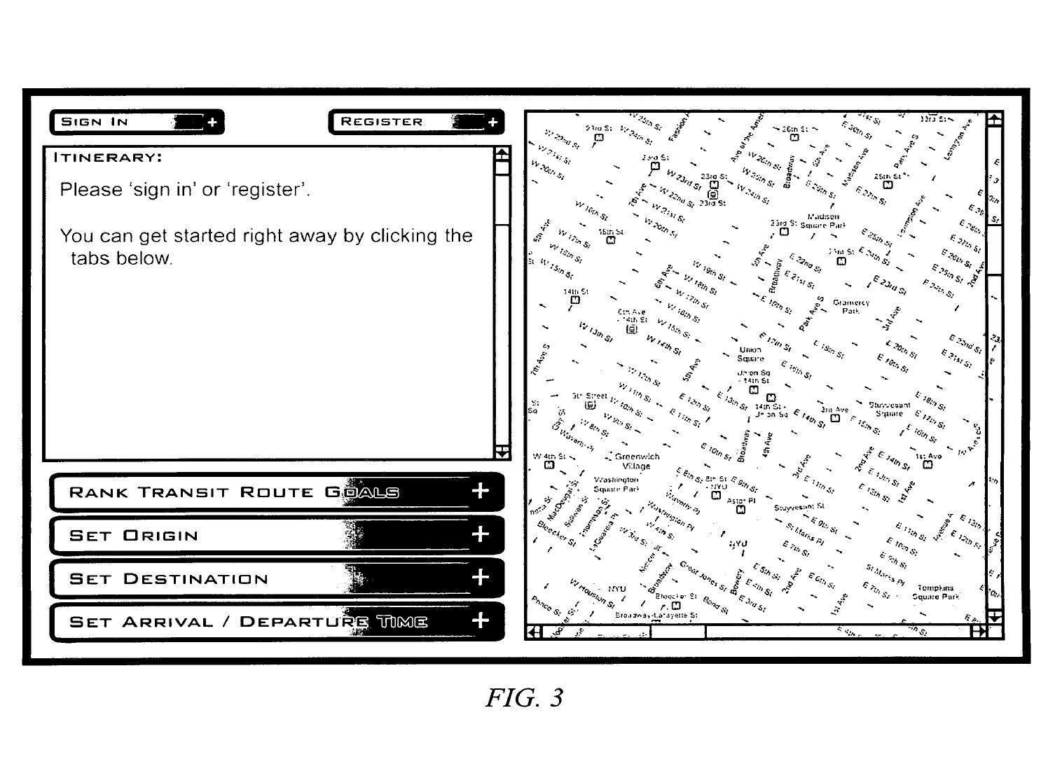

A user, or specifically, a commuter 200 accesses a central system 208 through an interface 210. FIG. 3 is a screen shot of a GUI of the system, according to an embodiment of the present invention. A preferred embodiment provides an interface via an application, which can be accessed from an internet-enabled source (e.g. a computer, PDA, etc.). Access may also be provided to the application via a mobile or cellular phone, allowing commuters without Internet access to use various features of the application via text message exchange and voice recognition. In another embodiment, an application is included within specific cellular phones.

A further embodiment of the present invention also provides access to the application via kiosks at transit hubs. These kiosks allow users to receive status updates, to sign-in for assistance with transportation forecasting, to make changes to their route, etc. The kiosks provide full application functionality, whereas access from a cell phone could be more limited.

In accordance with an embodiment of the present invention, commuters using the system are categorized into several user levels: ad-hoc users 232, registered users 234, partial subscription users 236, and total subscription users 238.

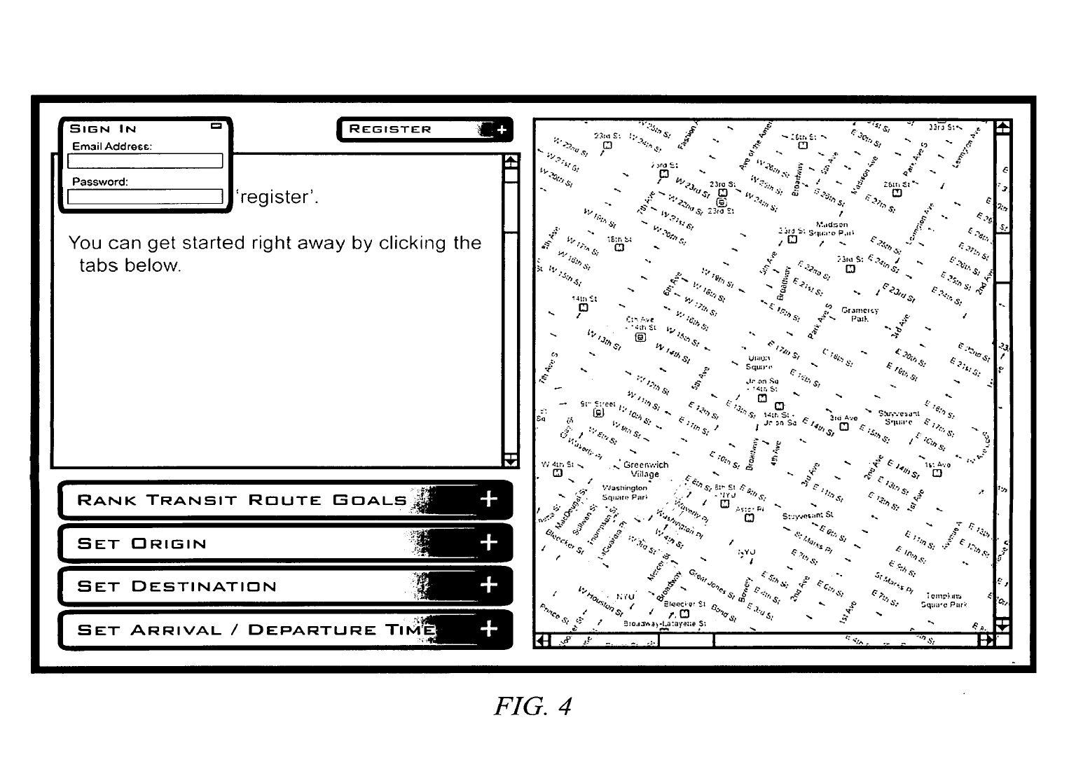

Registered users 234 preferably differ from ad-hoc users 232 in that their preferences, values, ranked goals, etc. are saved in and mapped by the system. A registered user 234 may simply sign in 240 and choose their point of departure 202, destination 204, and travel timing information 206. FIG. 4 is a screen shot of user sign-in in the system, according to an embodiment of the present invention.

Partial subscription users 236 are registered users 234 that have pre-scheduled a multi-modal transportation route in advance. Total subscription users 238 differ from partial subscription users 236 in that they have a regular schedule of routes. This enables total subscription users 238 to provide valuable forecasting information to transit providers, especially if they pre-pay their fares. Transit providers are then able to make resources available based partly on the number of users subscribed for their service, as well as in response to a contingency, as described in greater detail below.

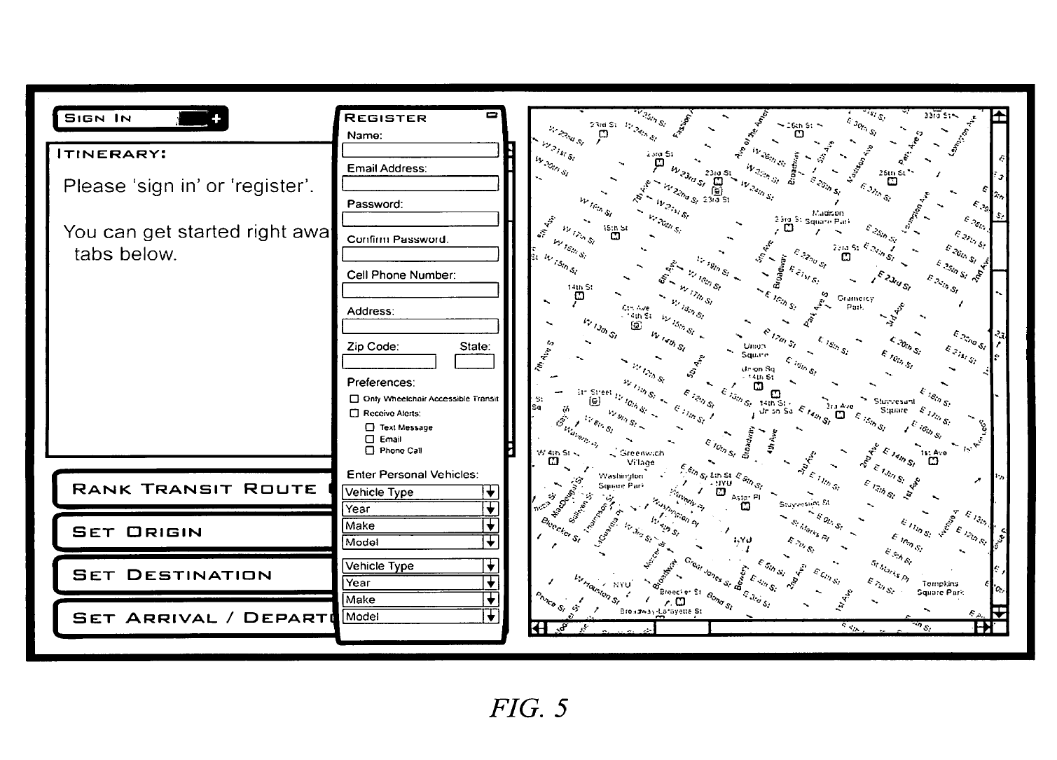

Ad-hoc users 232 are provided with the option to register 242, after which a registration process 244 is conducted before signing in 240. It is in the registration process 244 where the user first ranks their holistic transportation route goals. An ad-hoc user 232 that does not choose to register may still proceed with the data entry steps 202, 204, and 206, and the ranking of holistic transportation route goals 246 in block 248. FIG. 5 is a screen shot of user registration in the system, according to an embodiment of the present invention.

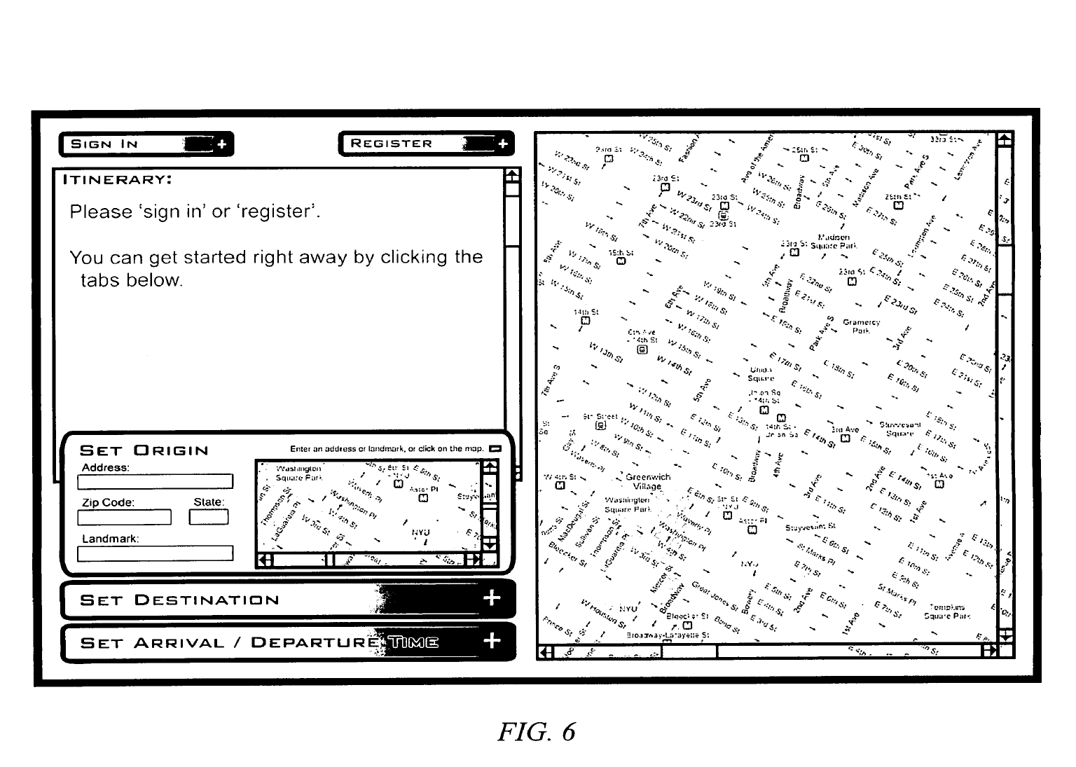

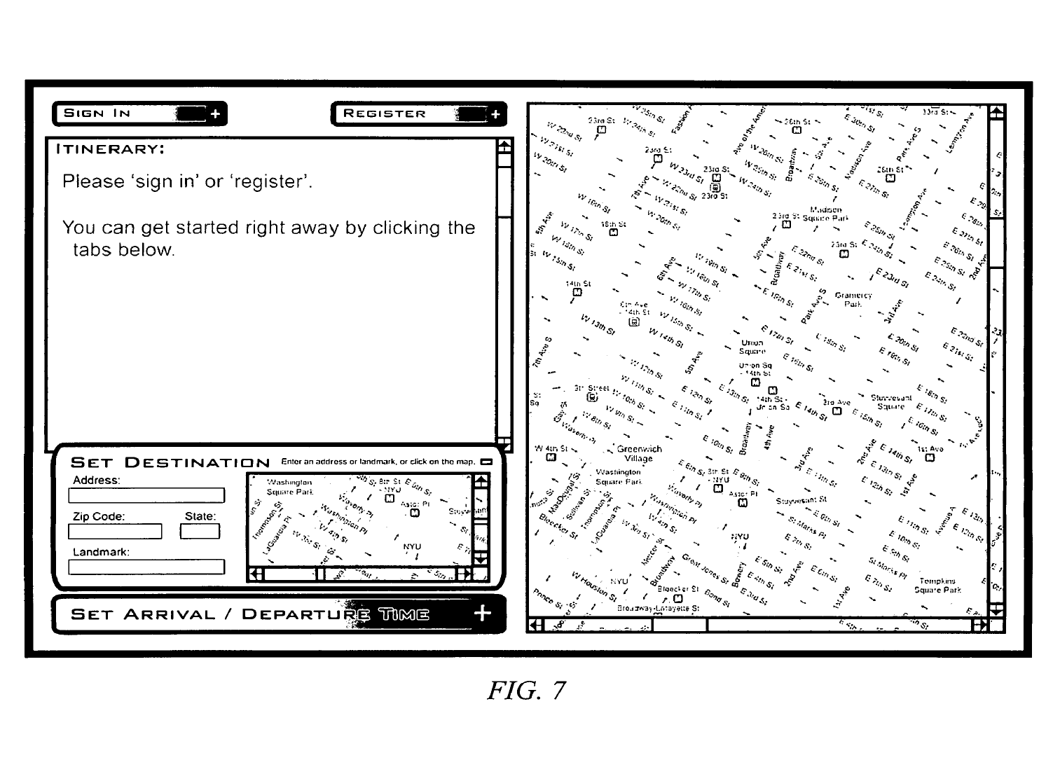

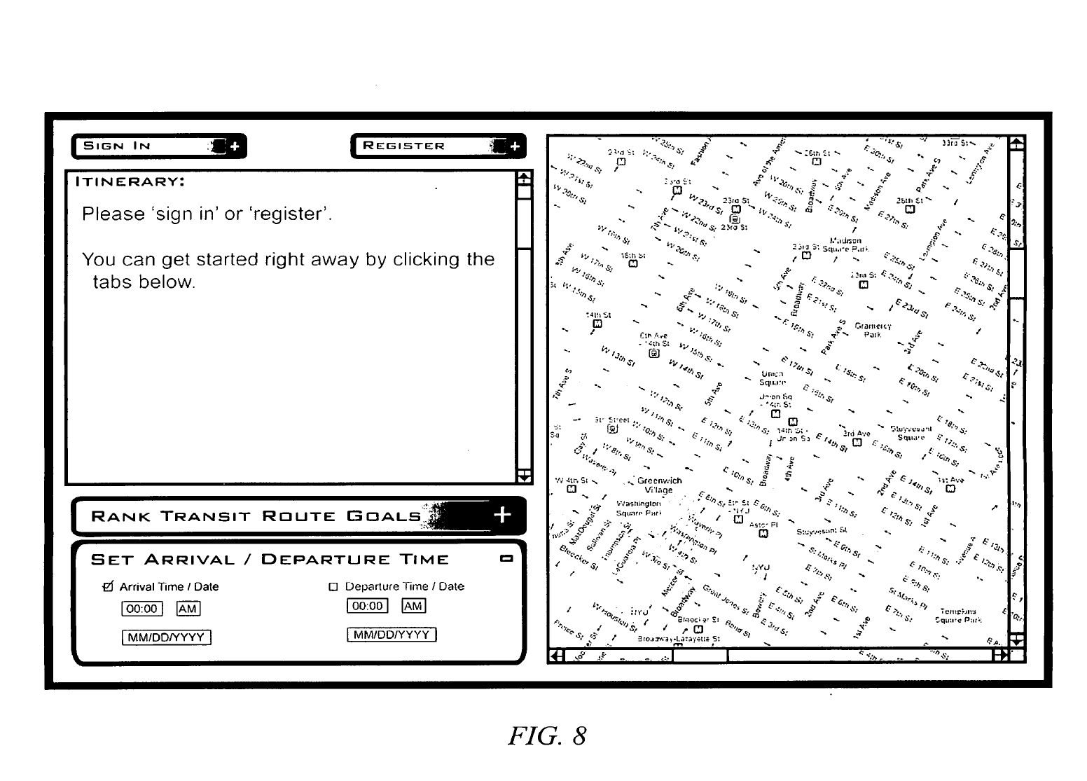

Referring back to FIG. 3, the commuter 200 defines a point of departure 202, a destination 204, and travel timing information 206. FIG. 6 is a screen shot of origin setting in the system, according to an embodiment of the present invention, which includes entry of an address or a landmark. FIG. 7 is a screen shot of destination setting in the system, according to an embodiment of the present invention, which also includes entry of an address or a landmark. FIG. 8 is a screen shot of arrival/departure time setting in the system, according to an embodiment of the present invention. The user may set an arrival time or a departure time.

In an embodiment of the present invention, holistic transportation route goals 246 are preset based on a combination of commuter transportation needs and individual values. Additional embodiments allow the user to create a database of prior goals, maintained by route and contingency efficacy, to provide a more robust and timely planning for future contingency. Table 1 provides some examples of holistic transportation route goals 246. Embodiments of the present invention allow the commuter 200 to assign a plurality of goals, ranked by importance, for use in planning daily and/or contingency transport.

TABLE 1
Sample Holistic Transportation Route Goals

Shortest travel time
Lowest cost
Wheelchair accessible transit
Least environmental impact
Probability of congestion delays
Best value for multiple destination trips
High level of safety
High level of security
High level of exclusivity
Smallest number of transfers
Lowest impact from weather
Use a personal automobile
Highest probability of finding parking
Lowest cost of parking
Greatest reliability
Greatest ability to multitask (e.g. use a laptop, read, talk
on a cell phone, etc.)

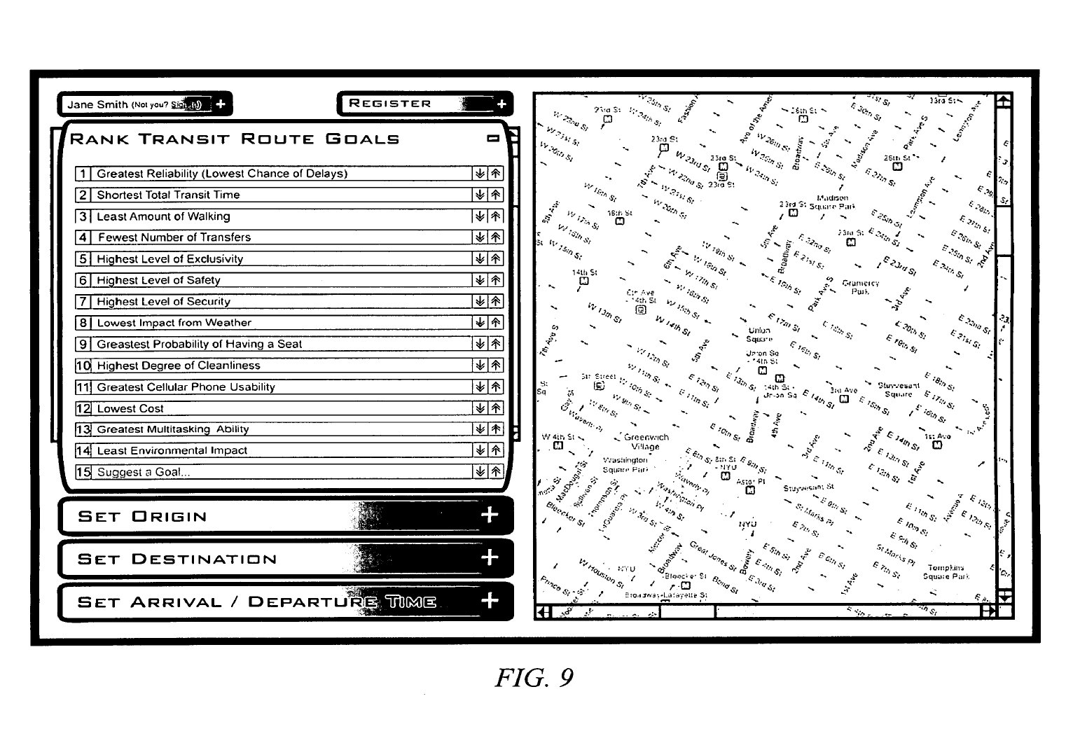

Embodiments of the present invention allow commuters traveling in a city to plan their personal transportation route based on their transportation needs and their individual values. These transportation needs and individual values include, but are not limited to: transit time, convenience, environmental impact such as air quality, weather, cost, number of mode switches, exclusivity, comfort, in-transit climate, cleanliness, ability to multitask, and payment method. FIG. 9 is a screen shot of transportation route goal ranking in the system by a user, according to an embodiment of the present invention.

Referring back again to FIG. 3, the central system 208 also receives attributes 250 of each transit mode 214, from real-time transit information 252. Embodiments of the present invention allow transit metrics or attributes 250, which were previously too time consuming or essentially unavailable for computation, to be factored as transit mode attributes in the planning of a multi-modal transportation route. These transit mode attributes 250 include but are not limited to, the environmental impact of a transit mode; parking considerations, such as probability of finding parking and the cost of parking; the levels of safety and security; the level of exclusivity; the level of accessibility; the probability of delays; and the probability of congestion. Some of these metrics were previously too time consuming to compute because of the amount of information necessary to consider, while others were previously not feasible to compute because of the lack of necessary information.

The central system 208 keeps real-time records of the transit mode attributes 250 through links to sensors, information feeds, or other systems that provide the necessary data. For example, in an embodiment of the present invention, a passenger counting mechanism can be used to show the capacity of each transit mode 214. Capacity reflects, among other things, the relative comfort of the ride and, in some cases, can be used as a proxy for seat availability.

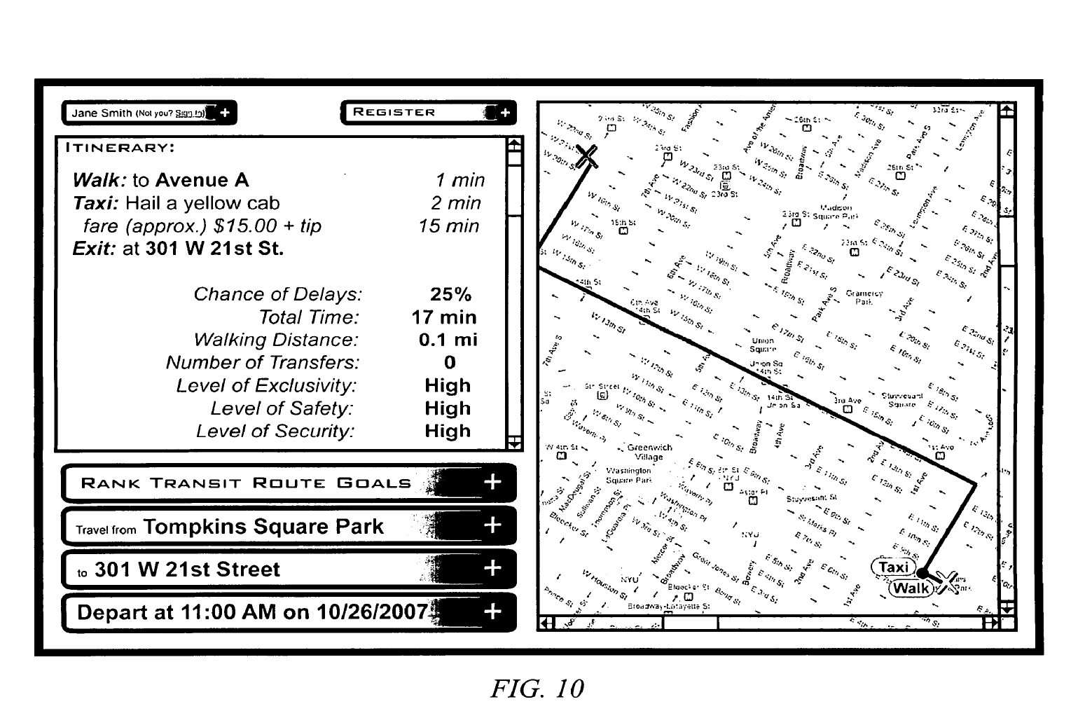

Referring back again to FIG. 3, the central system 208 outputs an optimized transportation route 216 to the commuter 200. FIG. 10 is a screen shot showing the itinerary output for a user, according to an embodiment of the present invention.

The environmental impact of each transit mode can be computed and used to calculate an environmental impact of the multi-modal transportation route. This allows the environmental values of a user to be included in the formation of the holistic transportation route goals. This also allows a system of carbon offsets to be linked with the application, providing users the option to offset the environmental impact of their optimized transportation route.

Parking considerations are often overlooked when a personal automobile is used as a transit mode. Most automobile travel times do not consider the time spent searching for parking. Additionally, the cost of parking, in the event that an available space cannot be located, must be considered. An embodiment of the present invention allows these parking considerations to be included in determination of the optimized transportation route and allows the user to accurately predict the time that may be saved by utilizing a personal automobile for only a portion of a transportation route. Probabilities can be used to determine the chance that a free parking space will be available, and the best and worst-case scenarios can be included. The cost of parking and the time spent searching for a spot can be included in the transit mode attributes for a personal automobile. The present invention allows feedback from parking availability monitors and sends notifications to the user if the parking situation changes within a desired, usable timeframe that corresponds to the commute. Tracking of parking capacity at viable nodes is also provided to improve the accuracy of the commute forecasting.

Another embodiment of the invention provides fully accessible transit as a holistic transportation route goal 246, resulting in an added level of mobility for disabled users. Relatively few mass transit modes exist that are truly disabled user accessible, and the present invention aggregates feedback from a plurality of users to broadcast a level of accessibility throughout the disabled community. In addition, embodiments of the present invention provide real-time change information about out-of-service wheelchair accessible areas, e.g. elevators, ramps, lifts, etc., which can often result in hours of delays and inconvenience in an otherwise typical commute.

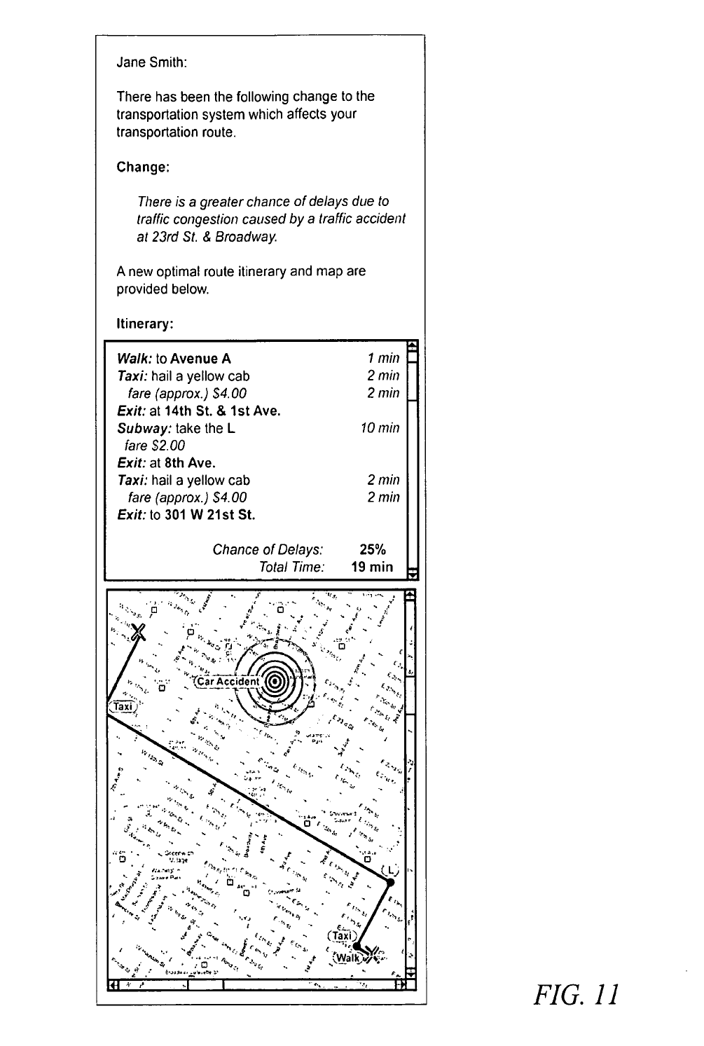

As shown in FIG. 3, if it has been determined that there has been a change to the transportation system 254, the central system 208 determines whether there is a new optimized transportation route 256. If there has been no change or the optimized transportation route remains unchanged, the central system 208 takes no further action. If there is a new optimized transportation route, the commuter 200 is notified of the change information and the new optimized route 230. FIG. 11 is a screen shot showing a notification of a change sent to a user, according to an embodiment of the present invention.

When a change to the transportation system forces a number of users to abandon a specific transit mode, new transit options can be made available based on a response from the users, and such new transit options can be brought on-line in a time efficient manner. For example, in an embodiment of the present invention a message is sent to users alerting them of the change to the transportation system, proposing alternative modes of transit such as taxis or buses that are routed to a specific node for bypass of the impacted transit segment, and asking if they would like to use such proposed alternatives. Based on the response, the alternative transit mode or alternative transportation route can be made available.

The present invention provides further advantages to the operators of the alternative transit modes by allowing registered users to confirm payment in advance of mobilization of the alternative transit, as well as reserving seating for each registered user who makes such advance payment, which can be made via kiosk, cell phone or other wireless device.

An additional purpose of the present invention is to forecast transit use. Establishing users' multi-modal transportation routes provides valuable information about the expected transit demand. The present invention allows for an early response to transit demands before they happen.

In another embodiment of the present invention the user has the option of rejecting part or all of the proposed route and allowing the computer to recalculate the route, or specifying certain portions of the route. The user can choose to receive notifications (e.g. a text message, phone call, email, etc.) if there are changes in the transportation system which would affect the multi-modal transportation route such as anomalous transportation system events, accidents, weather effects, etc. If there is an alternative route that would be more inline with the user's transportation needs and individual values, the alternative route will be suggested. An alarm clock alert may also be provided to wake users if, for example, the alternative route would require an earlier wake up time.

An additional embodiment of the present invention provides a method of pre-payment for various transit modes. User accounts can be linked with a user's credit card, and the application can prompt users to purchase the necessary tickets. This increases customer convenience and decreases the time spent at the transit station. Most transit tickets are useable at anytime, though scheduled, pre-paid service still provides a useful tool for better transit-use forecasting and bill collection. Better forecasting allows transportation systems to better handle surges in demand and non-uniform transit use, leading to better overall service and profitability. Additionally, when there is a change to the transportation system, users may be notified of the available alternative transit modes and alternative transportation routes and asked to respond with the new mode or route they will use. Based on the users' responses, additional units of an alternative transit mode can be introduced where they are needed.

Further, the cost of the transit mode may be modified based on users' reservations of that transit mode. This includes, but is not limited to, a user paying a lower fee for trips scheduled in advance and a user paying a lower fee as more users reserve a specific transit mode.

The system also allows for the development of a parking garage with rates that are not solely based on the time of entry and total parked time, but also the required level of flexibility in the exit time. For example, a user who knows they need their car between 6 and 6:15 pm would pay a lower fee than a user who knows they'll need it between 6 and 8 pm.

A further embodiment of the present invention allows users to enter various transit modes, which they personally own, such as personal automobiles, bicycles, skateboards, etc. The transit mode attributes can be estimated and each transit mode can be considered in the process of determining the optimized transportation route. A preferred embodiment allows transit vehicles to become traffic probes. The transit vehicles are preferably equipped with reporting systems that would allow each vehicle to act as a sensor in a citywide sensor network and can evaluate the traffic situation in its immediate surroundings. Transit vehicles may be quickly and easily deployed as emergency services vehicles in the event of an emergency. A further preferred embodiment provides users with several alternative multi-modal routes, to provide the users with several options, which will effectively meet their holistic transportation route goals.

A user's transportation route may also be linked to local businesses, entertainment, restaurants, parks, theatres, museums, etc. along the route. The application allows the user to search for attractions along his route and modify his route to include stops at these places. The application is linked to these businesses and services are selectively provided through it, including, but not limited to purchasing event tickets; viewing menus, making reservations and ordering food; checking availability of store items; checking and comparing prices; pre-purchasing items; and placing items on hold.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing a transportation route to a user comprising the steps of:
receiving travel information from the user, a plurality of transportation route goals ranked in a specified order by the user, and attribute information of a plurality of transit modes from a transit information system;
determining an optimized transportation route for the user through a correlation of the plurality of ranked transportation route goals and attribute information that corresponds to the received travel information, wherein the transportation route comprises one or more of the plurality of transit modes; and
transmitting the optimized transportation route to the user.

2. The method of claim 1, wherein the travel information comprises at least one of point of departure information, timing information, and destination information.

3. The method of claim 2, wherein the departure information and the destination information each comprise at least one of an address and a landmark, and the timing information comprises at least one of a departure time and an arrival time.

4. The method of claim 1, further comprising the step of providing access for a user through an interface.

5. The method of claim 4, wherein the user is provided access through at least one of a cellular phone and an internet enabled source.

6. The method of claim 4, further comprising the step of allowing a registered user to sign in, and providing an unregistered user with access to a registration process.

7. The method of claim 6, wherein at least one of preferences, values, ranked goals and routes of the registered user are stored and mapped.

8. The method of claim 1, wherein real-time records of the transit mode attributes are stored.

9. The method of claim 1, further comprising the steps of
determining whether there has been a change to the transportation system from the transit mode information attributes received from the transit information system;
determining whether there is a new optimized transportation route, when there has been a change to the transportation system; and
notifying the user of change information and the new optimized transportation route, when there is a new optimized transportation route.

10. The method of claim 1, further comprising the step of receiving user feedback regarding the plurality of transit modes and adjusting the determination of the optimized transportation route in accordance with the user feedback.

11. The method of claim 10, wherein the user feedback relates to disabled user accessibility of one or more of the plurality of transit modes, and further comprising the step of aggregating feedback from a plurality of users for calculation and transmission of a level of accessibility for the one or more of the plurality of transmit modes.

12. The method of claim 1, further comprising the step of recalculating the optimized transportation route after receiving a rejection of at least a portion of the previously presented optimized transportation route from the user.

13. The method of claim 1, further comprising the step of requesting and accepting pre-payment from the user of at least one of the one or more transit modes included in the optimized transportation route.

14. The method of claim 1, further comprising the step of modifying a cost associated with at least one of the one or more transit modes included in the optimized transportation route in accordance with reservations for the at least one of the one or more transit modes.

15. The method of claim 1, further comprising the step of receiving from the user one or more transit modes owned by the user, and determining the optimized transportation route in accordance with the one or more owned transit modes.

16. The method of claim 1, further comprising the step of linking the optimized transportation route to one or more local attractions on the optimized transportation route for presentation to the user.

17. The method of claim 1, wherein the attribute information comprises parking capacity and availability.

18. The method of claim 1, wherein at least one of the plurality of transportation route goals comprises environmental impact, and further comprising the steps of:
computing an environmental impact of each of the plurality of transit modes;
calculating an environmental impact of the optimized transportation route; and
linking carbon offsets to provide the user with an option of offsetting the environmental impact of the optimized transportation route.

19. An apparatus for providing a transportation route to a user that receives travel information from the user, a plurality of transportation route goals ranked in a specified order by the user, and attribute information of a plurality of transit modes from a transit information system, determines an optimized transportation route for the user through a correlation of the plurality of ranked transportation route goals and attribute information that corresponds to the received travel information, wherein the transportation route comprises one or more of the plurality of transit modes, and transmits the optimized transportation route to the user.

20. A system for providing a transportation route to a user comprising:
a transit information system that provides attribute information of a plurality of transit modes to a routing system; and
the routing system for receiving travel information from the user, a plurality of transportation route goals ranked in a specified order by the user, and attribute information of a plurality of transit modes from the transit information system, determining an optimized transportation route for the user through a correlation of the plurality of ranked transportation route goals and attribute information that corresponds to the received travel information, wherein the transportation route comprises one or more of the plurality of transit modes, and transmitting the optimized transportation route to the user.
